(19) United States
(12) Patent Application Publication
(10) Pub. No.: US 2014/0301239 A1
(43) Pub. Date: Oct. 9, 2014

(54) MOBILE COMMUNICATION METHOD, BASE STATION, AND USER TERMINAL

(71) Applicants: Noriyoshi Fukuta, Yokohama-shi (JP); Tohru Sunaga, Kawasaki-shi (JP)

(72) Inventors: Noriyoshi Fukuta, Yokohama-shi (JP); Tohru Sunaga, Kawasaki-shi (JP)

(73) Assignee: KYOCERA CORPORATION, Kyoto (JP)

(21) Appl. No.: 14/359,659

(22) PCT Filed: Nov. 28, 2011
(86) PCT No.: PCT/JP2011/077413

§ 371 Date: May 21, 2014

(51) Int. Cl. H04W 24/10

(52) U.S. Cl. CPC H04W 24/10
USPC 370/252

(57) ABSTRACT

A mobile communication method for a mobile communication method that includes UE supporting MDT (minimization of drive tests), and a network for communication with the UE, the method including: a step in which, after a UE has been selected to collect measurement data in an MDT, the UE receives a Logged Measurement Configuration from the network; and a step in which the UE carries out a measurement process on the network, in accordance with the Logged Measurement Configuration from the network. The Logged Measurement Configuration includes Trace information relating to the network entity that selected the UE to collect measurement data.

### TECHNICAL FIELD

The present invention relates to a mobile communication method, a base station, and a user terminal, in a mobile communication system based on the 3GPP standards.

### BACKGROUND ART

In a mobile communication system, if a building is built in the vicinity of a base station, or if the installation status of a base station in the vicinity of the base station changes, the radio communication environment according to the base station changes. Therefore, conventionally, operators make use of a measurement vehicle in which measurement equipment is loaded, and perform a drive test by measuring the state of a signal received from the base station, and then collecting the measurement data.

Such a measurement and collection process can, for example, contribute to the optimization of coverage of the base station, but face the problem of too many man-hours and high cost. In this regard, 3GPP (3rd Generation Partnership Project) which is a project aiming to standardize a mobile communication system has proceeded to design the specification of MDT (Minimization of Drive Tests) which is used for automation of the measurement and collection by using a user terminal owned by a user (see to Non Patent Literatures 1 and 2).

A type of the MDT is a record-type MDT (referred to as “Logged MDT”). In the current specification, according to the Logged MDT, a user terminal in an idle state measures a reception signal state in accordance with a measurement parameter (measurement condition) set from a network, records, as measurement data, a measurement result, location information, and time information, and reports the recorded measurement data to the network later.

Another type of the MDT is an immediate report-type MDT (referred to as “Immediate MDT”). In the current specification, according to the Immediate MDT, a user terminal in a connected state measures a reception signal state according to a measurement parameter (measurement condition) set from a network, and immediately reports, as measurement data, a measurement result and location information, to the network.

### CITATION LIST

### Non Patent Literature

[NPL 1] 3GPP TR 36.805 v9.0.0

[NPL 2] 3GPP TS 37.320 V10.2.0

### SUMMARY OF INVENTION

In the MDT, since a plurality of user terminals perform measurement under various conditions, it is considered that measurement data important for the network and unimportant measurement data are mixed. However, in the current specification, since all types of measurement data are equally processed, the network (that is, an operator) may not be capable of sufficiently collecting the important measurement data.

Therefore, the present invention provides a mobile communication method with which it is possible for a network to easily collect important measurement data, a base station thereof, and a user terminal thereof.

A mobile communication method according to the present invention is a mobile communication method in a mobile communication system including: a user terminal (for example, UE 200) that supports MDT (Minimization of Drive Tests); and a network (for example, E-UTRAN 10 and EPC 300) that communicates with the user terminal, comprising: a step A of transmitting MDT configuration information from the network to the user terminal, when the user terminal is selected for collecting measurement data in the MDT; and a step B of performing, by the user terminal, a measurement process on the network in accordance with the MDT configuration information from the network, wherein the MDT configuration information includes first information (for example, Trace information) on a network entity that selects the user terminal for collecting the measurement data.

According to another characteristic of the mobile communication method according to the present invention, the first information indicates whether or not the network entity that selects the user terminal for collecting the measurement data is a base station (for example, eNB 100).

According to another characteristic of the mobile communication method according to the present invention, the first information indicates either Management based trace procedure or Signaling based trace procedure, in the Management based trace procedure, the network entity that selects the user terminal for collecting the measurement data is a base station (for example, eNB 100), and in the Signaling based trace procedure, the network entity that selects the user terminal for collecting the measurement data is an upper device (for example, EM 320) of the base station.

According to another characteristic of the mobile communication method according to the present invention, in the step A, only when the network entity that selects the user terminal for collecting the measurement data is an upper device of the base station, the first information is included in the MDT configuration information.

According to another characteristic of the mobile communication method according to the present invention, the step B includes a step of recording a measurement result for the network, the mobile communication method further comprises a step C of transmitting availability information (for example, Availability Indicator) indicating availability of measurement data including the measurement result, from the user terminal to the network, and the step C includes a step of transmitting second information (for example, Trace information) corresponding to the first information and the availability information to the network.

According to another characteristic of the mobile communication method according to the present invention, a step D of transmitting, by the network, a request message (for example, UE Information Request) for requesting transmission of the measurement data on the basis of the availability information and the second information from the user terminal, to the user terminal, is further provided.

According to another characteristic of the mobile communication method according to the present invention, a step E of controlling, by the user terminal, the measurement process on the basis of a battery remaining amount of the user terminal and the first information, is further provided.

According to another characteristic of the mobile communication method according to the present invention, the step E includes a step of canceling the measurement process when the battery remaining amount falls below a battery threshold value and the first information indicates a base station.

According to another characteristic of the mobile communication method according to the present invention, the step E includes a step of continuing the measurement process when the battery remaining amount falls below the battery threshold value and the first information indicates an upper device of the base station.

According to another characteristic of the mobile communication method according to the present invention, the MDT configuration information further includes a measurement parameter for the measurement process, and the step E includes a parameter change step of changing the measurement parameter to restrain the measurement process when the battery remaining amount falls below a battery threshold value and the first information indicates a base station.

According to another characteristic of the mobile communication method according to the present invention, the measurement parameter includes a first recording interval, the step B includes a step of periodically recording a measurement result in accordance with the first recording interval, and the parameter change step includes a step of changing a current interval to a second recording interval that is longer than the first recording interval.

According to another characteristic of the mobile communication method according to the present invention, the measurement parameter includes a first threshold value, the step B includes a step of recording a measurement result triggered by a communication state being deteriorated more than the first threshold value, and the parameter change step includes a step of changing a threshold value to a second threshold value corresponding to the communication state deteriorated more than the first threshold value.

According to another characteristic of the mobile communication method according to the present invention, the measurement parameter includes a plurality of trigger types, the step B includes a step of recording a measurement result in accordance with the plurality of trigger types, and the parameter change step includes a step of changing some trigger types, out of the plurality of trigger types, to be not applied.

A bases station according to the present invention is a base station (for example, eNB 100) included in a network that communicates with a user terminal that supports MDT (Minimization of Drive Tests), comprising: a transmission unit (for example, a Configuration control unit 141 and a radio communication unit 110) that transmits MDT configuration information to the user terminal, after the user terminal is selected for collecting measurement data in the MDT, wherein the MDT configuration information includes first information on a network entity that selects the user terminal for collecting the measurement data.

A user terminal according to the present invention is a user terminal (for example, UE 200) that supports MDT (Minimization of Drive Tests), comprising: a reception unit (for example, radio communication unit 210) that receives MDT configuration information from a network, after the user terminal is selected for collecting measurement data in the MDT, wherein the MDT configuration information includes first information on a network entity that selects the user terminal for collecting the measurement data.

### BRIEF DESCRIPTION OF DRAWINGS

FIG. 1 is a diagram showing an entire configuration of a mobile communication system according to a first embodiment to a fifth embodiment.

FIG. 2 is a block diagram of eNB according to the first embodiment to the fifth embodiment.

FIG. 3 is a block diagram of UE according to the first embodiment to the fifth embodiment.

FIG. 4 is an operation flowchart of the UE according to the first embodiment, and shows an operation from setting of a measurement parameter to an end of logging.

FIG. 5 is an operation flowchart of the UE according to the first embodiment, and shows an operation after the end of logging.

FIG. 6 is an operation flowchart of the UE according to the second embodiment, and shows an operation from setting of a measurement parameter to an end of logging.

FIG. 7 is an operation flowchart of the UE according to the third embodiment, and shows an operation from setting of a measurement parameter to an end of logging.

FIG. 8 is an operation flowchart of the UE according to the fourth embodiment, and shows an operation from setting of a measurement parameter to an end of logging.

FIG. 9 is an operation flowchart of the UE according to the fifth embodiment, and shows an operation from setting of a measurement parameter to an end of logging.

### DESCRIPTION OF EMBODIMENTS

With reference to with drawings, a first embodiment to a fifth embodiment and other embodiments, of the present invention, will be described. In the drawings of each of the embodiments shown below, the same or similar symbols have been used in the same or similar portions.

### First Embodiment

### Entire Configuration of Mobile Communication System

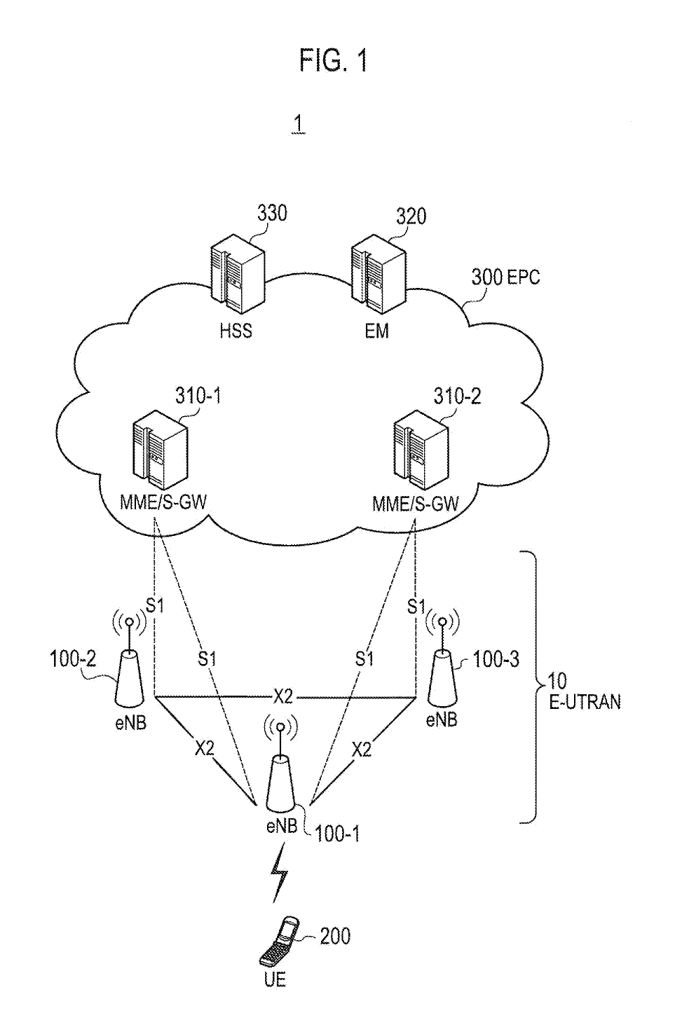

FIG. 1 is a diagram showing an entire configuration of a mobile communication system 1 according to the present embodiment. The mobile communication system 1 according to the present embodiment is configured based on LTE (Long Term Evolution) or LTE-Advanced for which the specification is set forth in 3GPP, and supports the above-described Logged MDT.

As shown in FIG. 1, the mobile communication system 1 includes eNB (evolved Node-B) 100, UE (User Equipment) 200, MME (Mobility Management Entity)/S-GW (Serving Gateway) 310, EM (Element Manager) 320, and HSS (Home Subscriber Server) 330. In FIG. 1, only one UE 200 is shown; however, actually, the mobile communication system 1 includes a large number of UEs 200.

The eNB 100 configures E-UTRAN (Evolved-UMTS Terrestrial Radio Access Network) 10, which is a radio access network of LTE. The MME/S-GWs 310, the EM 320, and the HSS 330 configure EPC (Evolved Packet Core) 300 which is a core network of LTE. In the present embodiment, the eNB 100 corresponds to a base station, and the UE 200 corresponds to a user terminal. Further, the E-UTRAN 10 and the EPC 300 configures a network.

Each eNB 100 is a fixed radio communication device set up by an operator, and is configured to perform radio communication with the UE 200. Each eNB 100 communicates with another adjacent eNB 100 on an X2 interface, and communicates with the MME/S-GW 310 on an Si interface. Each eNB 100 forms one or more cells, which are the smallest units of a radio communication area. Each eNB 100 always broadcasts a reference signal that enables the identification of cells.

The UE 200 is a transportable radio communication device carried by a user. The UE 200 has a battery and is driven by power accumulated in the battery. The UE 200 is configured to connect to the eNB 100 and to enable communication with a communication destination via the eNB 100. A state where the UE 200 is executing communication with the communication destination is called a connected state, and a state where the UE 200 is standing by for communication is called an idle state.

Although described in detail later, the eNB 100 transmits Logged Measurement Configuration, which is a message for performing the Logged MDT, to the UE 200 (in the connected state) connecting to the eNB 100. In the present embodiment, the Logged Measurement Configuration corresponds to MDT configuration information.

The UE 200 which has received the Logged Measurement Configuration performs, in an idle state, a measurement process in which a state of a signal received from the E-UTRAN 10 is measured and measurement data (also referred to as “measurement log”) including a measurement result is recorded. Such a measurement process in the Logged MDT is referred to as a “logging process”.

It is noted that the reception signal state is a reference signal received power (RSRP) and a reference signal received quality (RSRQ), for example. The measurement data includes a measurement result of the reception signal state, location information during measurement, and time information (time stamp) during measurement. The location information is GPS location information when the UE 200 has a GPS function, and is RF fingerprint information when the UE 200 does not have the GPS function.

The UE 200 holding the measurement data enters the connected state from the idle state, and then transmits the measurement data to the E-UTRAN 10 in response to a request from the E-UTRAN 10. The eNB 100 which has received the measurement data from the UE 200 transfers the received measurement data to OAM (not shown). An operator is capable of designating a location where a problem occurs in the network such as a coverage problem, from the measurement data transferred to the OAM. Further, the OAM may be capable of performing a network self optimization for resolving the problem.

While moving, the UE 200 switches serving cells. A cell switching performed when the UE 200 is in the connected state is called handover, and a cell switching performed when the UE 200 is in the idle state is called cell reselection. In the mobile communication system 1, one tracking area (TA) is configured by one or a plurality of cells. The TA is an area unit in which location registration and paging are performed.

The MME is configured to manage TA and/or a cell on which the UE 200 camps, and to perform various types of mobility managements for the UE 200. The S-GW is configured to perform transfer control of user data transmitted and received by the UE 200. The EM 320 offers a package for managing each entity (element) configuring the network. The HSS 330 manages subscriber information and handles service control and subscriber data.

In the mobile communication system 1, the UE used for collecting the measurement data in the MDT is selected by using either one of Management based trace procedure or Signaling based trace procedure. That is, in order that the UE used for the MDT is selected, a trace function of the subscriber/cell is reused and expanded.

The Management based trace procedure and the Signaling based trace procedure are described in detail in 3GPP TS 32.422, and the Management based trace procedure and the Signaling based trace procedure will be briefly described, below.

When the MDT is started to a particular UE 200, the Signaling based trace procedure is used. The particular UE 200 is indicated by IMSI (International Mobile Subscriber Identity), which is subscriber identification information, and/or IMEI (International Mobile Equipment Identity), which is UE identification information. Unless the MDT is started to a particular UE 200, the Management based trace procedure is used.

In the Management based trace procedure, the eNB 100 selects the UE 200 used for collecting the measurement data in the MDT, on the basis of information received from the EM 320 and MDT consent information saved in the eNB 100.

On the other hand, in the Signaling based trace procedure, the EM 320 designates a particular UE 200 by the IMSI and/or the IMEI, and notifies the eNB 100 of MDT Configuration via the HSS 330 and the MME 310. The EM 320 may further notify information on an area in which the MDT is carried out.

Hereinafter, the MME 310, the EM 320, and the HSS 330 are referred to as “upper device of the eNB 100”, where necessary.

The select of the UE by the Management based trace procedure or the Signaling based trace procedure applies both to the Logged MDT and the Immediate MDT, and description proceeds below with a focus mainly on the Logged MDT.

(Configuration of eNB)

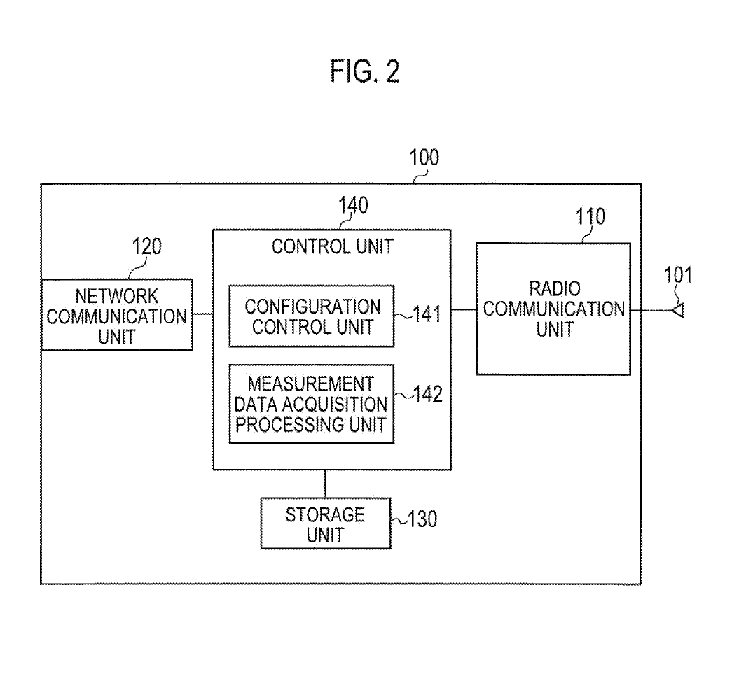

Next, a configuration of the eNB 100 will be described. FIG. 2 is a block diagram of the eNB 100.

As shown in FIG. 2, the eNB 100 includes an antenna 101, a radio communication unit 110, a network communication unit 120, a storage unit 130, and a control unit 140.

The antenna 101 is used for transmitting and receiving a radio signal. The radio communication unit 110 is configured by using a radio frequency (RF) circuit and a base band (BB) circuit, for example, and transmits and receives a radio signal via the antenna 101. The network communication unit 120 communicates with another network device (MME/S-GW 310, OAM, another eNB 100, etc.). The storage unit 130 is configured by using a memory, for example, and stores different types of information used for controlling, for example, the eNB 100. The control unit 140 is configured by using a processor, for example, and controls different types of functions provided in the eNB 100.

The control unit 140 includes a Configuration control unit 141 and a measurement data acquisition processing unit 142.

When the Signaling based trace procedure is concerned, the Configuration control unit 141 generates Logged Measurement Configuration on the basis of the MDT Configuration received by the network communication unit 120 from the upper device, and controls the radio communication unit 110 to transmit the Logged Measurement Configuration to the UE 200 designated by the IMSI and/or the IMEI from the upper device (that is, the UE 200 selected by the upper device).

When the Management based trace procedure is concerned, the Configuration control unit 141 voluntarily selects the UE used for collecting the measurement data in the MDT, generates the Logged Measurement Configuration, and controls the radio communication unit 110 to transmit the Logged Measurement Configuration to the selected UE 200.

The Logged Measurement Configuration includes various types of measurement parameters. Examples of the measurement parameter are a logging trigger (measurement trigger), a logging period (measurement period), a network absolute time, and a logging area. The logging trigger designates a trigger for performing a logging process. The logging trigger is “regularly” or “event trigger”. The logging period designates a period since the measurement parameter is set until the logging process is ended. The network absolute time serves as a time reference in the UE 200. The logging area is optional and designates a cell or TA in which the logging process should be performed.

The Configuration control unit 141 includes Trace information (first information) relating to the network entity that selects the UE 200 used for collecting the measurement data in the MDT, into the Logged Measurement Configuration. The Trace information indicates either one of the Management based trace procedure or the Signaling based trace procedure.

In the present embodiment, the Trace information is configured by a 1-bit flag “0” when the Management based trace procedure is concerned, and a 1-bit flag “1” when the Signaling based trace procedure is concerned, As described above, in the Management based trace procedure, it is the eNB 100 that selects the UE, and in the Signaling based trace procedure, it is the upper device of the eNB 100 that selects the UE.

It is noted that the upper device of the eNB 100 is capable of knowing more information than the information the eNB 100 can know. Further, an operator's intention is sufficiently reflected when the UE is selected on the basis of the Signaling based trace procedure. Therefore, when the UE 200 is selected by the Signaling based trace procedure, the importance is higher than when the UE 200 is selected by the Management based trace procedure.

The measurement data acquisition processing unit 142 performs a process of acquiring the measurement data from the UE 200. When the radio communication unit 110 receives Availability Indicator indicating the availability of the measurement data in the UE 200 (that is, holding the measurement data) and when it is determined that the measurement data is acquired, the measurement data acquisition processing unit 142 generates a UE Information Request message for acquiring the measurement data, and controls the radio communication unit 110 to transmit the UE Information Request message to the UE 200.

In the present embodiment, the UE 200 stores the Trace information received from the network, and when transmitting the Availability Indicator to the network, transmits the stored Trace information (second information) to the network.

Then, the measurement data acquisition processing unit 142 decides whether or not to acquire the measurement data on the basis of the Trace information received by the radio communication unit 110 from the UE 200. For example, when the Trace information indicates the Signaling based trace procedure, the measurement data acquisition processing unit 142 increases a probability to decide to acquire the measurement data held by the UE 200 than a case where the Trace information indicates the Management based trace procedure.

The measurement data acquisition processing unit 142 acquires the measurement data included in a received UE Information Response message when the radio communication unit 110 receives the UE Information Response message transmitted from the UE 200 in response to the UE Information Request message. Then, the measurement data acquisition processing unit 142 controls the network communication unit 120 to transfer the acquired measurement data to the upper device. It is noted that in addition to a case where the measurement data acquisition processing unit 142 transfers the measurement data to the upper device, the measurement data acquisition processing unit 142 may interpret a content of the measurement data and use it for a parameter adjustment of the eNB 100 itself.

(Configuration of UE)

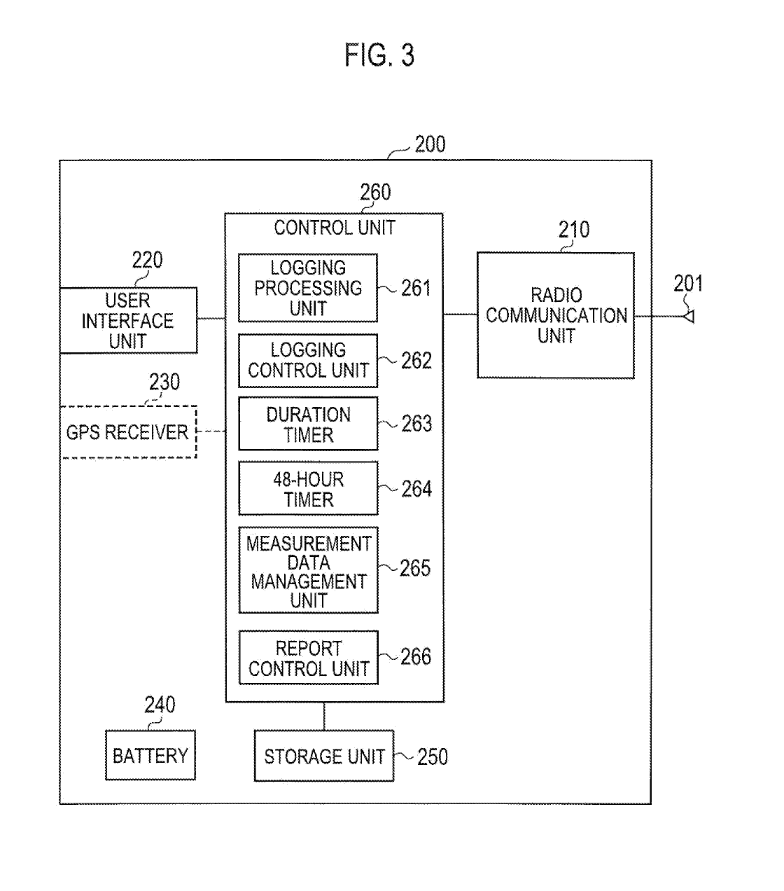

Next, the configuration of the UE 200 will be described. FIG. 3 is a block diagram of the UE 200.

As shown in FIG. 3, the UE 200 includes an antenna 201, a radio communication unit 210, a user interface unit 220, a GPS receiver 230, a battery 240, a storage unit 250, and a control unit 260. However, the UE 200 need not include the GPS receiver 230.

The antenna 201 is used for transmitting and receiving a radio signal. The radio communication unit 210 is configured by using a radio frequency (RF) circuit and a base band (BB) circuit, for example, and transmits and receives a radio signal via the antenna 201. The user interface unit 220 is a display that functions as an interface with a user, button, or the like. The battery 240 is a chargeable battery, which accumulates power to be supplied to each block of the UE 200. The storage unit 250 is configured by using a memory, for example, and stores various types of information used for controlling UE 200, for example. The control unit 260 is configured by using a processor, for example, and controls various types of functions provided in the UE 200.

The control unit 260 includes a logging processing unit 261 that performs a logging process, a logging control unit 262 that controls the logging process, a Duration timer 263 that counts a logging period, a 48-hour timer 264 that counts 48 hours, a measurement data management unit 265 that manages the measurement data, and a report control unit 266 that controls a report of the measurement data to the network.

In the connected state, when the radio communication unit 210 receives the Logged Measurement Configuration, the logging control unit 262 sets (that is, houses in the storage unit 250) the measurement parameter included in the received Logged Measurement Configuration. Furthermore, the logging control unit 262 houses the Trace information included in the Logged Measurement Configuration, into the storage unit 250. The logging processing unit 261 sets the logging period, out of the measurement parameters, to the Duration timer 263, and activates the Duration timer 263.

In the idle state, the logging processing unit 261 performs the logging process according to the measurement parameter stored in the storage unit 250. More particularly, if a trigger designated by the logging trigger, out of the measurement parameters, is generated, then the reception signal state is measured, and the measurement data including a measurement result, location information, and time information is recorded (that is, accumulated in the storage unit 250). Here, the location information included in the measurement data (log) is the latest information within a valid time. Furthermore, the time information is generated on the basis of a network absolute time, out of the measurement parameters. In addition, when the logging area, out of the measurement parameters, is set, the logging processing unit 261 performs the logging process in a cell or TA designated by the logging area.

The logging control unit 262 activates the Duration timer 263 and then monitors the Duration timer 263. If the Duration timer 263 expires, then the logging control unit 262 controls the logging processing unit 261 to end the logging process, releases the setting of the measurement parameter, and activates the 48-hour timer 264.

After the logging period expires, the measurement data management unit 265 holds the measurement data in the storage unit 250 until the 48-hour timer 264 expires and deletes the measurement data when the 48-hour timer 264 expires.

When the measurement data is held in the storage unit 250, the report control unit 266 monitors whether or not a transmission trigger of Availability Indicator is generated. The transmission trigger of the Availability Indicator is a transition from the idle state to the connected state (RRC connection establishment), execution of handover (RRC connection re-establishment), and a new setting at an upper layer (RRC re-configuration).

When the measurement data is held in the storage unit 250, if the transmission trigger of the Availability Indicator is generated, the report control unit 266 acquires the Trace information held in the storage unit 250 and transmits the Availability Indicator and the Trace information to the network. For example, when the transmission trigger of the Availability Indicator is detection of the transition from the idle state to the connected state, the report control unit 266 controls to transmit the Availability Indicator and the Trace information into an RRC Connection Setup Complete message, to the network. It is noted that the RRC Connection Setup Complete message is a message indicating that the transition from the idle state to the connected state is completed.

If the UE Information Request message transmitted from the eNB 100 in response to the Availability Indicator is received in the radio communication unit 210, the report control unit 266 acquires the measurement data held in the storage unit 250, and controls to transmit the measurement data into the UE Information Response message, to the network. When the measurement data is transmitted (reported) in this way, the measurement data management unit 265 deletes the measurement data held in the storage unit 250.

(Operation of UE)

Hereinafter, an operation of the UE 200 associated with the Logged MDT will be described.

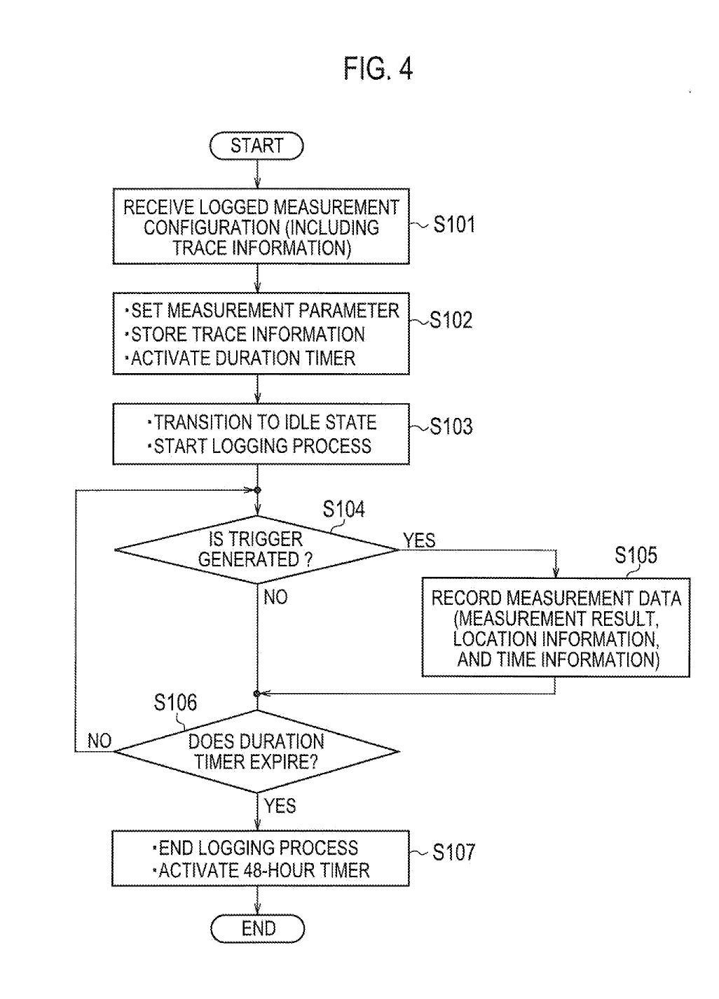

First, an operation from the setting of a measurement parameter to an end of logging will be described. FIG. 4 is an operation flowchart of the UE 200 according to the present embodiment, and shows the operation from the setting of a measurement parameter to the end of logging. In an initial state of FIG. 4, it is assumed that the UE 200 is in the connected state.

As shown in FIG. 4, in step S101, the radio communication unit 210 receives the Logged Measurement Configuration message from the eNB 100. The Logged Measurement Configuration includes the measurement parameter and the Trace information.

In step S102, the logging control unit 262 of the control unit 260 acquires and sets the measurement parameter included in the Logged Measurement Configuration received by the radio communication unit 210. More particularly, the logging control unit 262 sets the logging period, out of the measurement parameters, to the Duration timer 263 and activates the Duration timer 263, and houses a remaining measurement parameter in the storage unit 250. Furthermore, the logging control unit 262 houses the Trace information included in the Logged Measurement Configuration received by the radio communication unit 210, into the storage unit 250.

In step S103, the UE 200 enters the idle state and the logging control unit 262 starts the logging process.

In step S104, the logging processing unit 261 checks whether a trigger corresponding to the logging trigger, out of the measurement parameters, is generated. For example, when the logging trigger is “periodically”, the logging processing unit 261 checks whether a timing corresponding to a designated period is reached. When the logging trigger is an “event trigger” (for example, the reception signal state of a serving cell being falling below a threshold value), the logging processing unit 261 checks whether a designated event is generated. When the trigger corresponding to the logging trigger is not generated (step S104; NO), the process proceeds to step S106.

When the trigger corresponding to the logging trigger is generated (step S104; YES), in step S105, the logging processing unit 261 measures the reception signal state and houses the measurement data including the measurement result, the location information, and the time information, in the storage unit 250. Then, the process proceeds to step S106.

In step S106, the logging control unit 262 checks whether or not the Duration timer 263 expires. When the Duration timer 263 does not expire (step S106; NO), the process returns to step S104.

Meanwhile, when the Duration timer 263 expires (step S106; YES), the logging control unit 262 controls the logging processing unit 261 to end the logging process, and activates the 48-hour timer 264, in step S107.

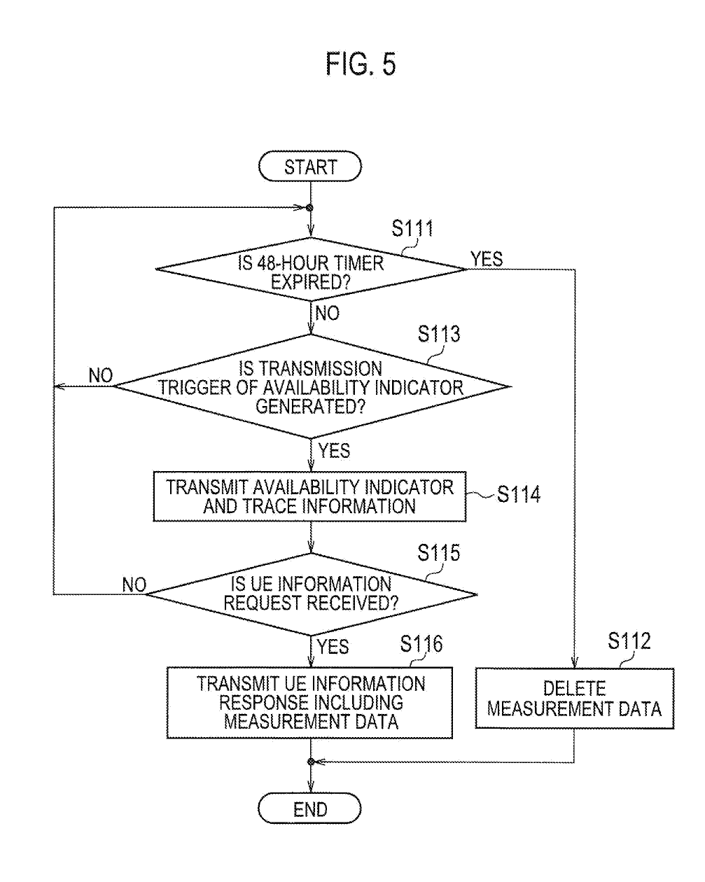

Next, an operation after the end of logging will be described. FIG. 5 is an operation flowchart of the UE 200 according to the present embodiment, and shows an operation after the end of logging.

As shown in FIG. 5, in step S111, the measurement data management unit 265 checks whether or not the 48-hour timer 264 expires. When the 48-hour timer 264 expires (step S111; YES), in step S112, the measurement data management unit 265 deletes the measurement data held in the storage unit 250.

Meanwhile, when the 48-hour timer 264 does not expire (step S111; NO), the report control unit 266 checks whether or not the transmission trigger of the Availability Indicator is generated, in step S113. In this case, as the transmission trigger of the Availability Indicator, transition from the idle state to the connected state is assumed. When the transmission trigger of the Availability Indicator is not generated (step S113; NO), the process returns to step S111.

On the other hand, when the transmission trigger of the Availability Indicator is generated (step S113; YES), in step S114, the report control unit 266 acquires the Trace information from the storage unit 250, and controls the radio communication unit 210 to transmit the Availability Indicator and the Trace information into an RRC Connection Setup Complete message, to the eNB 100. It is noted that it is highly probable that the eNB 100, to which the Availability Indicator is transmitted, is different from the eNB 100 from which the Logged Measurement Configuration is transmitted.

In step S115, the report control unit 266 checks whether or not the radio communication unit 210 receives the UE Information Request message from the eNB 100. When the radio communication unit 210 does not receive the UE Information Request message (step S115; NO), the process returns to step S111.

On the other hand, when the radio communication unit 210 receives the UE Information Request message (step S115; YES), the report control unit 266 acquires the measurement data held in the storage unit 250, and controls the radio communication unit 210 to transmit the measurement data into the UE Information Response message, to the eNB 100, in step S116.

(Conclusion)

As described above, in the present embodiment, the eNB 100 transmits the Logged Measurement Configuration including the Trace information, to the UE 200, and the UE 200 stores the Trace information. The UE 200 transmits the stored Trace information to the eNB 100, when transmitting the Availability Indicator indicating the availability of the measurement data, to the network.

As a result, the network is capable of determining whether or not to acquire the measurement data held in the UE 200 in consideration of whether the UE 200 is selected by the Management based trace procedure or the Signaling based trace procedure. For example, it becomes possible to run the MDT in which the measurement data of the UE 200 selected by the Signaling based trace procedure is preferentially acquired. Therefore, it is easy for the network to collect the measurement data having a high importance.

### Second Embodiment

Below, a second embodiment will be described with a focus on a difference from the above-described embodiment.

In the Logged MDT, the UE 200 continuously performs the logging process until the logging period designated from the network expires, and thus, the UE 200 consumes more power than a case where such a process is not performed. As a result, when a battery remaining amount of the UE 200 is completely consumed, it is not possible to perform incoming and outgoing calls even if it is urgent. Therefore, in each of the below embodiments, description will be given on a method of reducing a possibility that the battery remaining amount of the UE 200 is completely consumed.

In the present embodiment, when the battery remaining amount falls below a battery threshold value, the UE 200 decides on the basis of the Trace information whether or not it is possible to cancel the logging. Then, the UE 200 cancels the logging when it is possible to cancel the logging.

In the present embodiment, the storage unit 250 of the UE 200 previously stores the battery threshold value. The battery threshold value is set to be larger than zero. For example, even when the battery remaining amount reaches the battery threshold value, the battery threshold value preferably is set to a value allowing for at least emergency incoming and outgoing calls (for a certain period of time). In the present embodiment, it is assumed that the battery threshold value is previously stored in the storage unit 250. As described above, the battery remaining amount is expressed by a ratio (percentage) of a battery voltage value, and thus, the battery threshold value also is expressed by a ratio (percentage) of a battery voltage value. As an example, the battery threshold value may be in a range of about 20% to about 40%.

Alternatively, the battery threshold value may be designated by the network. In this case, the network includes the battery remaining amount into the Logged Measurement Configuration. The battery threshold value is decided according to a degree of importance of a logging process and a state of the UE 200, for example. For example, the following method may be possible: UE capability indicating a capability of the UE 200 is used to estimate a release the UE 200 may support, and when it is determined that the release is old, the UE is regarded as being used for long years, and the battery threshold value is set to a higher value than usual (that is, the logging is made to stop easily).

(Operation of UE)

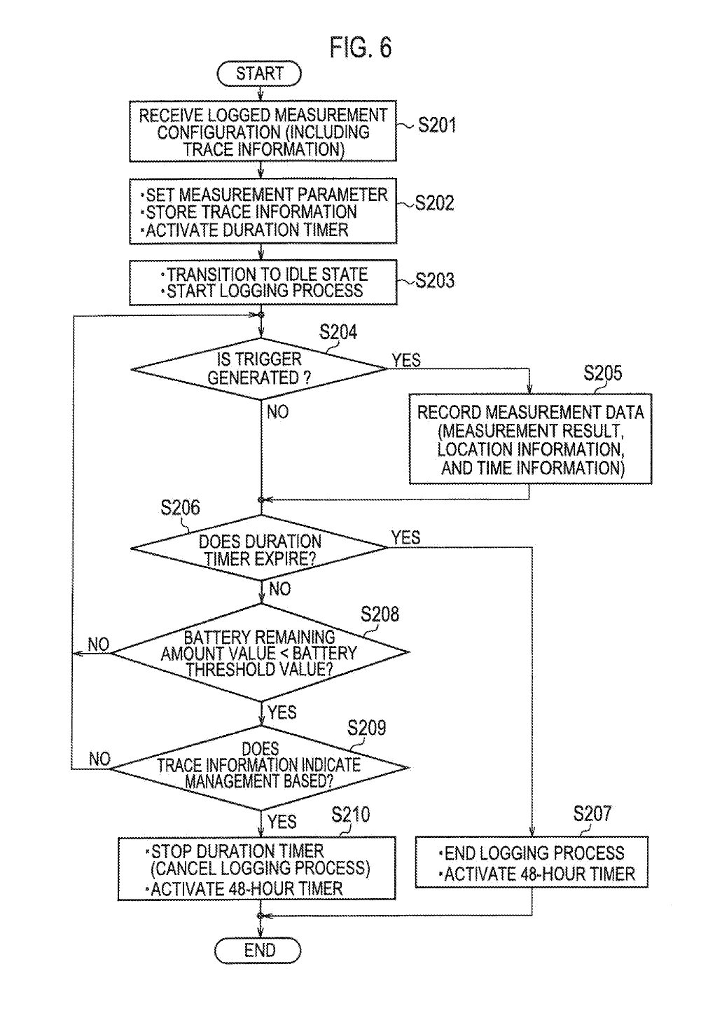

The operation of the UE 200 according to the present embodiment will be described below. FIG. 6 is an operation flowchart of the UE 200 according to the present embodiment, and shows an operation from the setting of a measurement parameter to the end of logging. In an initial state of FIG. 6, it is assumed that the UE 200 is in the connected state.

As shown in FIG. 6, in step S201, the radio communication unit 210 receives the Logged Measurement Configuration from the eNB 100. In the present embodiment, the Logged Measurement Configuration includes the above-mentioned Trace information in addition to a measurement parameter such as a logging trigger, a logging period, a network absolute time, and a logging area.

In step S202, the logging control unit 262 of the control unit 260 acquires and sets the measurement parameter included in the Logged Measurement Configuration received by the radio communication unit 210. More particularly, the logging control unit 262 sets the logging period, out of the measurement parameters, to the Duration timer 263 and activates the Duration timer 263, and houses a remaining measurement parameter in the storage unit 250. Furthermore, the logging control unit 262 houses the Trace information included in the Logged Measurement Configuration, into the storage unit 250.

In step S203, the UE 200 enters the idle state and the logging control unit 262 starts the logging process. In the present embodiment, the logging control unit 262 monitors a remaining amount of the battery 240 (battery remaining amount) during the logging period. The battery remaining amount is determined according to a voltage value of the battery 240. In the present embodiment, the battery remaining amount is a ratio (percentage) of a current voltage value with respect to a maximum voltage value of the battery 240. The battery remaining amount value is normally used and displayed on a display included in the user interface unit 220, and thus, it is possible for the report control unit 266 to relatively easily acquire the battery remaining amount value.

In step S204, the logging processing unit 261 checks whether or not a trigger corresponding to the logging trigger, out of the measurement parameters, is generated. For example, when the logging trigger is “periodically”, the logging processing unit 261 checks whether a timing corresponding to a designated period is reached. When the logging trigger is a “specific trigger” (for example, the reception signal state of a serving cell being falling below a threshold value), the logging processing unit 261 checks whether or not a designated trigger is generated. When the trigger corresponding to the logging trigger is not generated (step S204; NO), the process proceeds to step S206.

When the trigger corresponding to the logging trigger is generated (step S204; YES), in step S205, the logging processing unit 261 measures the reception signal state, acquires the location information and time information, and houses the measurement data including the measurement result, the location information, and the time information, into the storage unit 250. Then, the process proceeds to step S206.

In step S206, the logging control unit 262 checks whether or not the Duration timer 263 expires.

When the Duration timer 263 expires (step S206; YES), the logging control unit 262 controls the logging processing unit 261 to end the logging process, and activates the 48-hour timer 264, in step S207.

Meanwhile, when the Duration timer 263 does not expire (step S206; NO), the logging control unit 262 checks whether or not a battery remaining amount value falls below a battery threshold value, in step S208. When the battery remaining amount value does not fall below the battery threshold value (step S208; NO), the process returns to step S204.

On the other hand, when the battery remaining amount value falls below the battery threshold value (step S208; YES), in step S209, the logging control unit 262 checks whether or not the Trace information indicates the Management based trace procedure or indicates the Signaling based trace procedure. When the Trace information indicates the Signaling based trace procedure (step S209; NO), it is determined that the cancellation of the logging process is not permitted and the process returns to step S204.

Meanwhile, when the Trace information indicates the Management based trace procedure (step S209; YES), it is determined that the cancellation of the logging process is permitted, and in step S210, the logging control unit 262 controls the logging processing unit 261 to cancel the logging process, forcedly stops the Duration timer 263, and activates the 48-hour timer 264.

(Conclusion)

As described above, according to the present embodiment, the UE 200 cancels the logging process, when the logging process is being executed, when the battery remaining amount value falls below the battery threshold value, and the Trace information indicates the Management based trace procedure (that is, the network entity that decides to cause the UE 200 to perform the logging process is the eNB 100).

On the other hand, the UE 200 continues the logging process rather than cancels the same, when the logging process is being executed, even when the battery remaining amount value falls below the battery threshold value, and the Trace information indicates the Signaling based trace procedure (that is, the network entity that decides to cause the UE 200 to perform the logging process is the upper device of the eNB 100).

As a result, when the battery remaining amount of the UE 200 is small, it is possible to determine whether or not to cancel the logging process in consideration of a degree of importance of the logging process.

### Third Embodiment

Below, a third embodiment will be described with a focus on a difference from the above-described embodiments.

The third embodiment to a fifth embodiment below will be based on the second embodiment; however, the logging process is not to be canceled but the logging trigger is changed to restrain the logging process.

In the present embodiment, “periodically” is designated as the logging trigger. In this case, the logging trigger defines a logging interval (recording interval), which is a period in which the logging process is performed. It is defined that the interval during which the logging process is performed is a multiple of an idle mode DRX.

During the logging period, when the battery remaining amount value falls below the battery threshold value and it is determined on the basis of the Trace information that the change of the logging interval is permitted, the logging control unit 262 of the UE 200 changes a current logging interval to a second logging interval (second recording interval) which is longer than a first logging interval (first recording interval) as the measurement parameter designated from the network.

Information indicating the second logging interval (information on how long the logging interval is extended, for example) is previously stored in the storage unit 250, and with reference to the information, the logging control unit 262 decides the second logging interval. Alternatively, the second logging interval may be designated by the network (eNB 100). In this case, the information indicating the second logging interval is included in the Logged Measurement Configuration.

(Operation of UE)

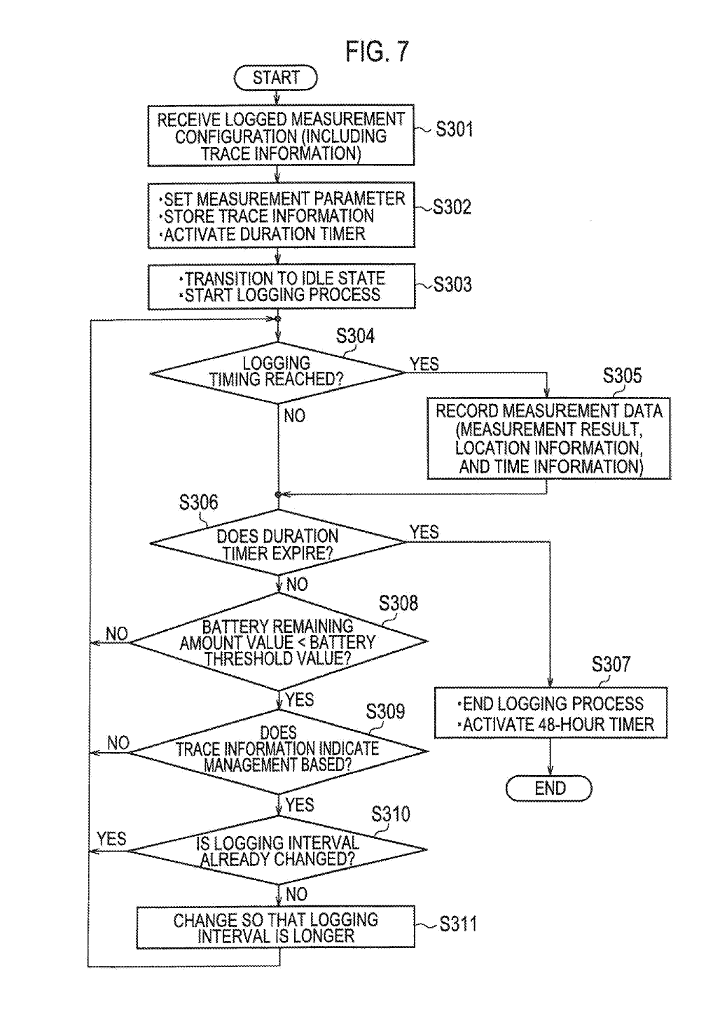

FIG. 7 is an operation flowchart of the UE 200 according to the present embodiment, and shows an operation from the setting of a measurement parameter to the end of logging. In an initial state of FIG. 7, it is assumed that the UE 200 is in the connected state.

As shown in FIG. 7, in step S301, the radio communication unit 210 receives the Logged Measurement Configuration from the eNB 100.

In step S302, the logging control unit 262 of the control unit 260 acquires and sets the measurement parameter included in the Logged Measurement Configuration received by the radio communication unit 210. More particularly, the logging control unit 262 houses the first logging interval, out of the measurement parameters, into the storage unit 250. Further, the logging control unit 262 sets the logging period, out of the measurement parameters, to the Duration timer 263 and activates the Duration timer 263, and houses a remaining measurement parameter in the storage unit 250. Furthermore, the logging control unit 262 houses the Trace information included in the Logged Measurement Configuration, into the storage unit 250.

In step S303, the UE 200 enters the idle state and the logging control unit 262 controls the logging processing unit 261 to start the logging process. More particularly, the logging control unit 262 sets the first logging interval to an internal timer for counting a logging interval installed in the logging processing unit 261, and activates the internal timer.

In step S304, the logging processing unit 261 checks whether or not a logging timing corresponding to the first logging interval, out of the measurement parameters, is reached. More particularly, the logging processing unit 261 checks whether or not the internal timer for counting the logging interval expires. When the logging timing corresponding to the first logging interval is not reached (step S304; NO), the process proceeds to step S306.

On the other hand, when the logging timing corresponding to the first logging interval is reached (step S304; YES), in step S305, the logging processing unit 261 measures the reception signal state and houses the measurement data including the measurement result, the location information, and the time information, into the storage unit 250. Then, the process proceeds to step S306.

In step S306, the logging control unit 262 checks whether or not the Duration timer 263 expires.

When the Duration timer 263 expires (step S306; YES), the logging control unit 262 controls the logging processing unit 261 to end the logging process and activates the 48-hour timer 264, in step S307.

Meanwhile, when the Duration timer 263 does not expire (step S306; NO), the logging control unit 262 checks whether or not the battery remaining amount value falls below a battery threshold value, in step S308. When the battery remaining amount value does not fall below the battery threshold value (step S308; NO), the process returns to step S304.

On the other hand, when the battery remaining amount value falls below the battery threshold value (step S308; YES), in step S309, the logging control unit 262 checks whether or not the Trace information indicates the Management based trace procedure or indicates the Signaling based trace procedure. When the Trace information indicates the Signaling based trace procedure (step S309; NO), the process returns to step S304.

Meantime, when the Trace information indicates the Management based trace procedure (step S309; YES), in step S310, the logging control unit 262 checks whether or not the logging interval is already changed. When the logging interval is already changed (step S310; YES), the process returns to step S304. When the logging interval is not yet changed (step S310; NO), the process proceeds to step S311.

In step S311, the logging control unit 262 controls the logging processing unit 261 to change a current interval to the second logging interval, which is longer than the first logging interval. More particularly, the logging control unit 262 sets the second logging interval instead of the first logging interval to an internal timer for counting a logging interval installed in the logging processing unit 261, and activates the internal timer. It is noted that even when the second logging interval is applied, it is desired that the time information (time stamp) that should be included in the measurement data is updated on the basis of the first logging interval. As a result, it is possible to maintain the accuracy of the time information (time stamp).

Upon completion of step S311, the process returns to step S304. In step S304 after the logging interval is changed, the logging processing unit 261 checks whether or not a logging timing corresponding to the second logging interval is reached. More particularly, the logging processing unit 261 checks whether or not the internal timer for counting the logging interval expires.

Thus, when the second logging interval which is an logging interval after the battery remaining amount value falls below the battery threshold value is made longer than the first logging interval which is a logging interval before the battery remaining amount value falls below the battery threshold value, it is possible to continue the logging process and reduce a logging frequency after the battery remaining amount value falls below the battery threshold value.

(Conclusion)

As described above, according to the present embodiment, the UE 200 periodically performs the logging process in accordance with the first logging interval designated from the network. Then, when the battery remaining amount value falls below the battery threshold value and the Trace information indicates the Management based trace procedure, the UE 200 changes a current interval to the second logging interval longer than the first logging interval. Meanwhile, when the battery remaining amount value falls below the battery threshold value and when the Trace information indicates the Signaling based trace procedure, the first logging interval is maintained without changing the current interval from the first logging interval to the second logging interval. As a result, when the battery remaining amount of the UE 200 is small, it is possible to suitably save the battery remaining amount in consideration of a degree of importance of the logging process.

### Fourth Embodiment

Below, a fourth embodiment will be described with a focus on a difference from the above-described embodiments.

In the present embodiment, not the “periodically” but the “event trigger” is designated as the logging trigger. When the event trigger is concerned, a specific event (for example, “the reception signal state of a serving cell being falling below the threshold value”) is used as a trigger to perform the logging.

In the present embodiment, the eNB 100 generates the Logged Measurement Configuration to designate the event trigger as the logging trigger. In this case, the Logged Measurement Configuration includes a trigger type of event triggers and a threshold value (first threshold value) corresponding to the trigger type, as the measurement parameter.

Examples of the trigger type of event triggers include “a reception signal state of the serving cell being falling below a threshold value” and “transmission power surplus (power headroom) of UE being falling below a threshold value”. When the Logged MDT in the idle state is concerned, “the reception signal state of the serving cell being falling below a threshold value” is applied as the trigger type of event triggers, for example.

Upon receipt of the Logged Measurement Configuration, the UE 200 sets (that is, stores, in the storage unit 250) the trigger type and the first threshold value included in the received Logged Measurement Configuration. Then, the UE 200 controls the logging processing unit 261 to apply the first threshold value at the time of starting the logging process, and controls the logging processing unit 261 to apply the second threshold value when the battery is low. In this case, the second threshold value is a value corresponding to a communication state deteriorated more than the first threshold value, that is, a value lower than the first threshold value.

It is noted that information indicating the second threshold value (information as to how far the threshold value is lowered, for example) is previously stored in the storage unit 250 of the UE 200, and the logging control unit 262 decides the second threshold value by referring to the information. Alternatively, the second threshold value may be designated by the eNB 100. In this case, the information on the second threshold value is included in the Logged Measurement Configuration.

(Operation of UE)

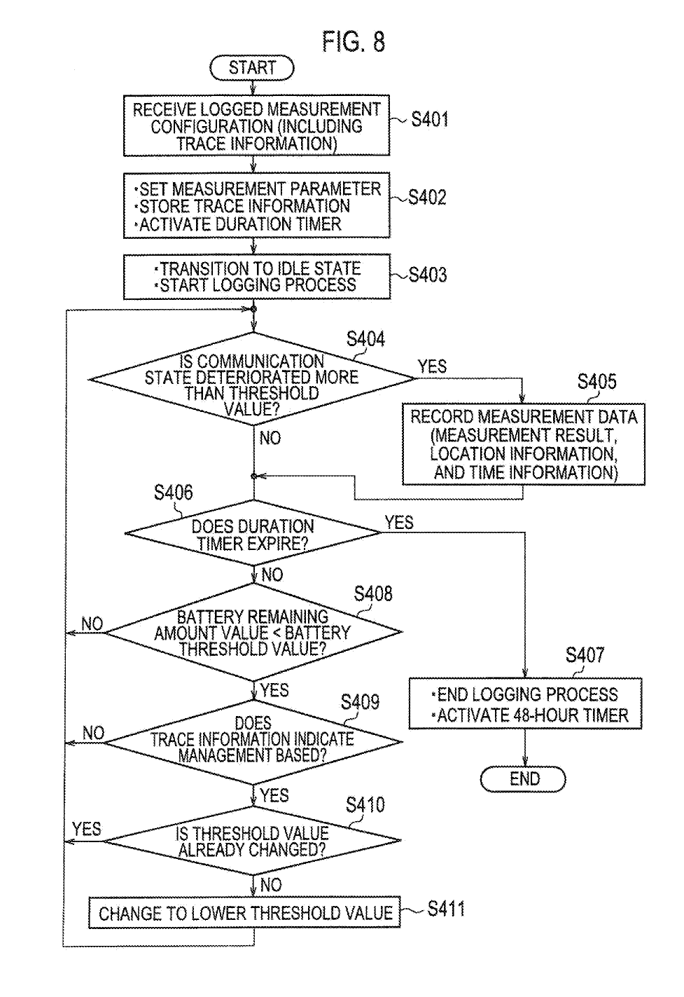

FIG. 8 is an operation flowchart of the UE 200 according to the present embodiment, and shows an operation from the setting of a measurement parameter to the end of logging. In an initial state of FIG. 8, it is assumed that the UE 200 is in the connected state.

As shown in FIG. 8, in step S401, the radio communication unit 210 receives the Logged Measurement Configuration from the eNB 100.

In step S402, the logging control unit 262 of the control unit 260 acquires and sets the measurement parameter included in the Logged Measurement Configuration received by the radio communication unit 210. More particularly, the logging control unit 262 houses the trigger type and the first threshold value, out of the measurement parameters, into the storage unit 250. Further, the logging control unit 262 sets the logging period, out of the measurement parameters, to the Duration timer 263 and activates the Duration timer 263, and houses a remaining measurement parameter in the storage unit 250. Furthermore, the logging control unit 262 houses the Trace information included in the Logged Measurement Configuration, into the storage unit 250.

In step S403, the UE 200 enters the idle state and the logging control unit 262 controls the logging processing unit 261 to start the logging process. More particularly, the logging control unit 262 controls the logging processing unit 261 to measure the communication state corresponding to the trigger type, out of the measurement parameters.

In step S404, the logging processing unit 261 compares the communication state corresponding to the trigger type with the first threshold value, and checks whether or not the communication state corresponding to the trigger type is deteriorated more than the first threshold value. When the communication state corresponding to the trigger type is deteriorated less than the first threshold value (step S404; NO), the process proceeds to step S406.

On the other hand, when the communication state corresponding to the trigger type is deteriorated more than the first threshold value (step S404; YES), in step S405, the logging processing unit 261 houses the measurement data including the measurement result of the communication state corresponding to the trigger type, the location information, and the time information, into the storage unit 250. Then, the process proceeds to step S406.

In step S406, the logging control unit 262 checks whether or not the Duration timer 263 expires.

When the Duration timer 263 expires (step S406; YES), the logging control unit 262 controls the logging processing unit 261 to end the logging process and activates the 48-hour timer 264, in step S407.

Meanwhile, when the Duration timer 263 does not expire (step S406; NO), the logging control unit 262 checks whether or not the battery remaining amount value falls below a battery threshold value, in step S408. When the battery remaining amount value does not fall below the battery threshold value (step S408; NO), the process returns to step S404.

On the other hand, when the battery remaining amount value falls below the battery threshold value (step S408; YES), in step S409, the logging control unit 262 checks whether or not the Trace information indicates the Management based trace procedure or indicates the Signaling based trace procedure. When the Trace information indicates the Signaling based trace procedure (step S409; NO), the process returns to step S404.

Meantime, when the Trace information indicates the Management based trace procedure (step S409; YES), in step S410, the logging control unit 262 checks whether or not the threshold value is already changed. When the threshold value is already changed (step S410; YES), the process returns to step S404. When the threshold value is not yet changed (step S410; NO), the process proceeds to step S411.

In step S411, the logging control unit 262 controls the logging processing unit 261 to change a current threshold value to the second threshold value corresponding to the communication state deteriorated more than the first threshold value. When the trigger type is “a reception signal state of the serving cell being falling below a threshold value”, the second threshold value is a value lower than the first threshold value.

Upon completion of step S411, the process returns to step S404. In step S404 after the threshold value is changed, the logging processing unit 261 checks whether or not the communication state corresponding to the trigger type is deteriorated more than the second threshold value.

Thus, when the second threshold value which is a threshold value after the battery remaining amount value falls below the battery threshold value is made lower than the first threshold value which is a threshold value before the battery remaining amount value falls below the battery threshold value, it is possible to continue the logging process and reduce a logging frequency obtained after the battery remaining amount value falls below the battery threshold value.

(Conclusion)

As described above, according to the present embodiment, the UE 200 performs the logging process in accordance with the first threshold value designated from the network. Then, when the battery remaining amount value falls below the battery threshold value and the Trace information indicates the Management based trace procedure, the UE 200 changes a current threshold value to the second threshold value lower than the first threshold value. Meanwhile, when the battery remaining amount value falls below the battery threshold value and when the Trace information indicates the Signaling based trace procedure, the first threshold value is maintained without changing the current threshold value from the first threshold value to the second threshold value. As a result, when the battery remaining amount of the UE 200 is small, it is possible to suitably save the battery remaining amount in consideration of a degree of importance of the logging process.

### Fifth Embodiment

Below, a fifth embodiment will be described with a focus on a difference from the above-described embodiments.

In the present embodiment, a plurality of trigger types including the “periodically” and/or the “event trigger” are designated. In the present embodiment, the eNB 100 generates the Logged Measurement Configuration including a plurality of trigger types as the logging trigger. In this case, the Logged Measurement Configuration includes a plurality of trigger types and accompanying information (logging interval and a threshold value) for each of the plurality of trigger types, as the measurement parameter.

Then, the eNB 100 transmits the Logged Measurement Configuration including a plurality of trigger types and the accompanying information (logging interval and a threshold value) for each of the plurality of trigger types, to the UE 200 in the connected state.

In the present embodiment, in the connected state, when the radio communication unit 210 receives the Logged Measurement Configuration, the logging control unit 262 of the UE 200 sets (that is, stores, in the storage unit 250) the plurality of trigger types and the accompanying information (logging interval and a threshold value) for each of the plurality of trigger types included in the received Logged Measurement Configuration.

Then, the logging control unit 262 controls the logging processing unit 261 to apply the plurality of trigger types at the time of starting the logging process, and controls the logging processing unit 261 not to apply some trigger types out of the plurality of trigger types when the battery is low.

It is noted that information indicating the trigger type not to be applied (for example, information as to what trigger type is to be not applied) is previously stored in the storage unit 250 of the UE 200, and the logging control unit 262 decides the trigger type not to be applied by referring to the information. Alternatively, some trigger types not to be applied may be designated by the network (eNB 100). In this case, information indicating some trigger types not to be applied is included in the Logged Measurement Configuration.

(Operation of UE)

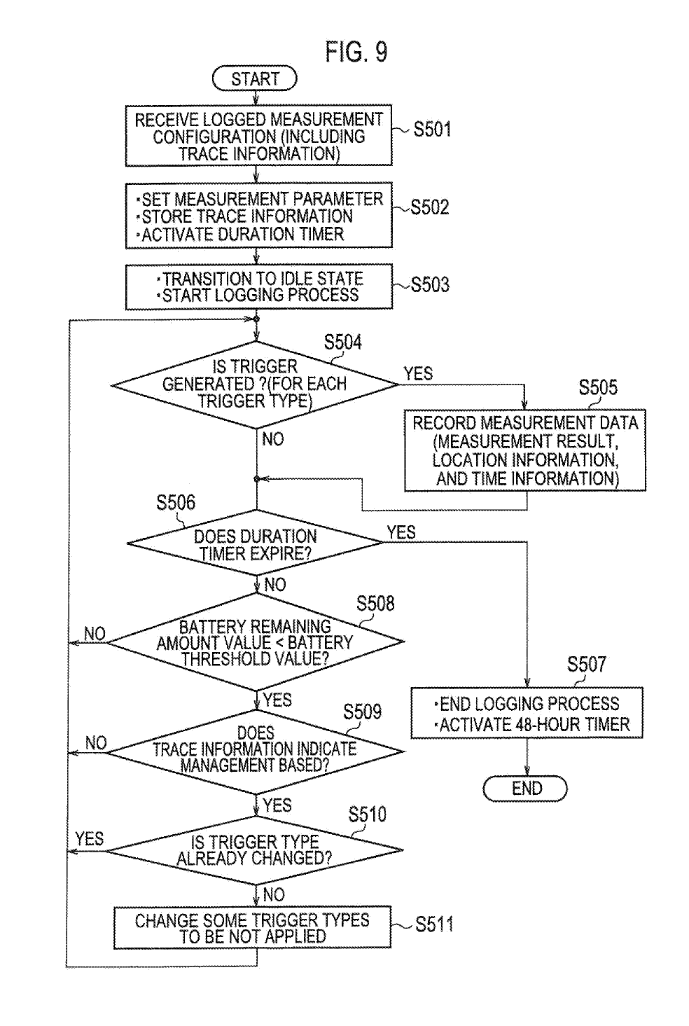

The operation of the UE 200 according to the present embodiment will be described below. FIG. 9 is an operation flowchart of the UE 200 according to the present embodiment, and shows an operation from the setting of a measurement parameter to the end of logging. In an initial state of FIG. 9, it is assumed that the UE 200 is in the connected state.

As shown in FIG. 9, in step S501, the radio communication unit 210 receives the Logged Measurement Configuration from the eNB 100.

In step S502, the logging control unit 262 of the control unit 260 acquires and sets the measurement parameter included in the Logged Measurement Configuration received by the radio communication unit 210. More particularly, the logging control unit 262 houses the plurality of trigger types and the accompanying information, out of the measurement parameters, into the storage unit 250. Further, the logging control unit 262 sets the logging period, out of the measurement parameters, to the Duration timer 263 and activates the Duration timer 263, and houses a remaining measurement parameter in the storage unit 250. Furthermore, the logging control unit 262 houses the Trace information included in the Logged Measurement Configuration, into the storage unit 250.

In step S503, the UE 200 enters the idle state and the logging control unit 262 controls the logging processing unit 261 to start the logging process. More particularly, the logging control unit 262 controls the logging processing unit 261 to measure a communication state corresponding to the plurality of trigger types, out of the measurement parameters.

In step S504, the logging processing unit 261 checks whether or not a logging trigger is generated for each of the plurality of trigger types. When the logging trigger corresponding to the trigger type is not generated (step S504; NO), the process proceeds to step S506.

On the other hand, when the logging trigger corresponding to the trigger type is generated (step S504; YES), in step S505, the logging processing unit 261 houses the measurement data including the measurement result of the communication state corresponding to the trigger type, the location information, and the time information, into the storage unit 250. Then, the process proceeds to step S506.

In step S506, the logging control unit 262 checks whether or not the Duration timer 263 expires.

When the Duration timer 263 expires (step S506; YES), the logging control unit 262 controls the logging processing unit 261 to end the logging process and activates the 48-hour timer 264, in step S507.

Meanwhile, when the Duration timer 263 does not expire (step S506; NO), the logging control unit 262 checks whether or not the battery remaining amount value falls below a battery threshold value, in step S508. When the battery remaining amount value does not fall below the battery threshold value (step S508; NO), the process returns to step S504.

On the other hand, when the battery remaining amount value falls below the battery threshold value (step S508; YES), in step S509, the logging control unit 262 checks whether or not the Trace information indicates the Management based trace procedure or indicates the Signaling based trace procedure. When the Trace information indicates the Signaling based trace procedure (step S509; NO), the process returns to step S504.

Meantime, when the Trace information indicates the Management based trace procedure (step S509; YES), the logging control unit 262 checks whether or not the trigger type is already changed (deleted). When the trigger type is already changed (step S509; YES), the process returns to step S504. When the trigger type is not yet changed (step S509; NO), the process proceeds to step S511.

In step S511, the logging control unit 262 controls some trigger types, out of the plurality of trigger types, not to be applied as the measurement parameter. More particularly, the logging control unit 262 controls the storage unit 250 to delete some trigger types stored in the storage unit 250, or controls the logging processing unit 261 to ignore the some trigger types stored in the storage unit 250.

Upon completion of step S511, the process returns to step S504. In step S504 after deleting the trigger type, the logging processing unit 261 checks whether or not a logging trigger is generated for a trigger type that is not to be not applied.

Thus, when the number of trigger types after the battery remaining amount value falls below the battery threshold value is made smaller than the number of trigger types before the battery remaining amount value falls below the battery threshold value, it is possible to continue the logging process and reduce a logging frequency obtained after the battery remaining amount value falls below the battery threshold value.

(Conclusion)

As described above, according to the present embodiment, the UE 200 performs the logging process on the E-UTRAN 10 in accordance with the plurality of trigger types designated from the network. Then, when the battery remaining amount value falls below the battery threshold value and the Trace information indicates the Management based trace procedure, the UE 200 changes some trigger types, out of the plurality of trigger types, to be not applied. Meanwhile, when the battery remaining amount value falls below the battery threshold value and the Trace information indicates the Signaling based trace procedure, the plurality of trigger types are maintained without changing some trigger types, out of the plurality of trigger types, to be not applied. As a result, when the battery remaining amount of the UE 200 is small, it is possible to suitably save the battery remaining amount in consideration of a degree of importance of the logging process.

### Other Embodiments

While the present invention has been described by way of each of the foregoing embodiments, as described above, it should not be understood that the statements and drawings forming a part of this disclosure limit the invention. From this disclosure, a variety of alternate embodiments, examples, and applicable techniques will become apparent to one skilled in the art.

For example, the Trace information may be “1” when the Signaling based trace procedure is concerned, and may be “not available” when the Management based trace procedure is concerned. In this case, the network (eNB 100) includes the Trace information (“1”) into the Logged Measurement Configuration, only when the Signaling based trace procedure is concerned.

In each embodiment described above, an example has been explained, in which the present invention is applied to the Logged MDT in Idle that is Logged MDT of a mode in which the logging process is performed by the UE 200 in an idle state. However, the present invention may also be applied to Logged MDT in Connected that is Logged MDT of a mode in which the logging process is performed by the UE 200 in a connected state. Moreover, the present invention is not limited to the Logged MDT. For example, the present invention may also be applied to Immediate MDT. According to the Immediate MDT, the UE 200 in the connected state performs the measurement, and immediately reports (transmits) the measurement data including a measurement result to a network (see the 3GPP TS 37.320 v10.1.0).

Furthermore, in each embodiment described above, an example of the mobile communication system configured based on LTE was explained, however, in addition to LTE, the present invention may also be applied to another mobile communication system supporting MDT (for example, W-CDMA).

### INDUSTRIAL APPLICABILITY

As described above, according to the mobile communication method, the base station, and the user terminal of the present invention, it is possible for a network to easily collect important measurement data, and thus, the present invention is useful for radio communication such as a mobile communication.

1. A mobile communication method in a mobile communication system including a user terminal that supports MDT (Minimization of Drive Tests), and a network that communicates with the user terminal, comprising:
a step A of transmitting MDT configuration information from the network to the user terminal, when the user terminal is selected for collecting measurement data in the MDT; and
a step B of performing, by the user terminal, a measurement process on the network in accordance with the MDT configuration information from the network, wherein
the MDT configuration information includes first information on a network entity that selects the user terminal for collecting the measurement data.

2. The mobile communication method according to claim 1, wherein
the first information indicates whether or not the network entity that selects the user terminal for collecting the measurement data is a base station.

3. The mobile communication method according to claim 2, wherein
the first information indicates either Management based trace procedure or Signaling based trace procedure,
in the Management based trace procedure, the network entity that selects the user terminal for collecting the measurement data is a base station, and
in the Signaling based trace procedure, the network entity that selects the user terminal for collecting the measurement data is an upper device of the base station.

4. The mobile communication method according to claim 1, wherein
in the step A, only when the network entity that selects the user terminal for collecting the measurement data is an upper device of a base station, the first information is included in the MDT configuration information.

5. The mobile communication method according to claim 1, wherein
the step B includes a step of recording a measurement result for the network,
the mobile communication method further comprises a step C of transmitting availability information indicating availability of measurement data including the measurement result, from the user terminal to the network, and
the step C includes a step of transmitting second information corresponding to the first information and the availability information to the network.

6. The mobile communication method according to claim 5, further comprising:
a step D of transmitting, by the network, a request message for requesting transmission of the measurement data on the basis of the availability information and the second information from the user terminal, to the user terminal.

7. The mobile communication method according to claim 1, further comprising:
a step E of controlling, by the user terminal, the measurement process on the basis of a battery remaining amount of the user terminal and the first information.

8. The mobile communication method according to claim 7, wherein
the step E includes a step of canceling the measurement process when the battery remaining amount falls below a battery threshold value and the first information indicates a base station.

9. The mobile communication method according to claim 7, wherein
the step E includes a step of continuing the measurement process when the battery remaining amount falls below the battery threshold value and the first information indicates an upper device of the base station.

10. The mobile communication method according to claim 7, wherein
the MDT configuration information further includes a measurement parameter for the measurement process, and
the step E includes a parameter change step of changing the measurement parameter to restrain the measurement process when the battery remaining amount falls below a battery threshold value and the first information indicates a base station.

11. The mobile communication method according to claim 10, wherein
the measurement parameter includes a first recording interval,
the step B includes a step of periodically recording a measurement result in accordance with the first recording interval, and
the parameter change step includes a step of changing a current interval to a second recording interval that is longer than the first recording interval.

12. The mobile communication method according to claim 10, wherein
the measurement parameter includes a first threshold value,
the step B includes a step of recording a measurement result triggered by a communication state being deteriorated more than the first threshold value, and
the parameter change step includes a step of changing a threshold value to a second threshold value corresponding to the communication state deteriorated more than the first threshold value.

13. The mobile communication method according to claim 10, wherein
the measurement parameter includes a plurality of trigger types,
the step B includes a step of recording a measurement result in accordance with the plurality of trigger types, and
the parameter change step includes a step of changing some trigger types, out of the plurality of trigger types, to be not applied.

14. A bases station included in a network that communicates with a user terminal that supports MDT (Minimization of Drive Tests), comprising:
a transmission unit that transmits MDT configuration information to the user terminal, when the user terminal is selected for collecting measurement data in the MDT, wherein
the MDT configuration information includes first information on a network entity that selects the user terminal for collecting the measurement data.

15. A user terminal that supports MDT (Minimization of Drive Tests), comprising:
a reception unit that receives MDT configuration information from a network, when the user terminal is selected for collecting measurement data in the MDT, wherein
the MDT configuration information includes first information on a network entity that selects the user terminal for collecting the measurement data.
